(19) United States
(12) Patent Application Publication
(10) Pub. No.: US 2022/0191058 A1
(43) Pub. Date: Jun. 16, 2022

(54) ON-BOARD SYSTEM, ON-BOARD SYSTEM CONTROL METHOD, AND NON-TRANSITORY RECORDING MEDIUM

(71) Applicant: TOYOTA JIDOSHA KABUSHIKI KAISHA, Toyota-shi (JP)

(72) Inventors: Erika ISHII, Toyota-shi (JP); Yasuaki MORITA, Nisshin-shi (JP)

(73) Assignee: TOYOTA JIDOSHA KABUSHIKI KAISHA, Toyota-shi (JP)

(21) Appl. No.: 17/530,946

(22) Filed: Nov. 19, 2021

(30) Foreign Application Priority Data
Dec. 14, 2020 (JP) 2020-206618

(51) Int. Cl. H04L 12/40; G06F 1/3287

(52) U.S. Cl. CPC H04L 12/40; H04L 2012/40273; H04L 2012/40215; G06F 1/3287

(57) ABSTRACT

An on-board system that includes: a plurality of electronic controllers; and a gateway electronically connected to the plurality of electronic controllers, the gateway including memory and a processor coupled to the memory, and the processor being configured to perform control to cause the plurality of electronic controllers to sleep when no sleep-disabling request is sent from outside the on-board system, and perform control to prevent the plurality of electronic controllers from sleeping when a sleep-disabling request is sent from outside the on-board system, wherein the processor is configured to, when a predetermined condition is satisfied, perform control to cause the plurality of electronic controllers to sleep even when the sleep-disabling request is sent from outside the on-board system.

### CROSS-REFERENCE TO RELATED APPLICATION

This application is based on and claims priority under 35 USC 119 from Japanese Patent Application No. 2020-206618 filed on Dec. 14, 2020, the disclosure of which is incorporated by reference herein.

### BACKGROUND

### Technical Field

The present disclosure relates to an on-board system, an on-board system control method, and a non-transitory recording medium.

### Related Art

Plural electronic control units (ECUs) are installed in a vehicle. The ECUs are connected by an on-board network that is a Controller Area Network (CAN) or the like. The ECUs are equipped with functions such as network management (NM) functions and so forth that reduce power consumption when the ignition is turned off (the term “IG-OFF” is used below). The NM functions are functions that perform control to switch each ECU into a normal state, a sleep state or the like at the same time. The meaning of the term “sleep” as used herein is intended to include a transition to a low-energy mode in which power consumption of the ECUs is suppressed. The meaning of the term “wakeup” as used herein is intended to include a transition from a low-energy mode to a mode operating with usual power consumption.

Japanese Patent Application Laid-Open (JP-A) No. 2002-041141 discloses a system that uses network management functions to cause a set of ECUs to go to sleep and to wake up from sleep. In a state in which the ECUs cannot sleep even when a certain duration has passed, the system records factors of the state in which sleep is not possible and detects abnormalities.

Factors in wakeups of ECUs include factors arising from vehicle occupants and factors arising from requests from outside the system. When a wakeup is continually requested from the outside, no measure is available to forcibly block the requests and cause the ECUs to sleep. Moreover, when a wakeup is continually requested from the outside, information of an error that continues the wakeup is not recorded in normal processing, and no method is available for identifying what cause is running down a battery. Consequently, it is very difficult to investigate factors in the battery running down. Volumes of communication between vehicles and the outside are expected to increase relentlessly in the future. Technologies that facilitate investigation of factors in batteries running down are called for.

### SUMMARY

An aspect of the disclosure is an on-board system that includes a plurality of electronic controllers and a gateway electronically connected to the plurality of electronic controllers. The gateway includes a memory and a processor coupled to the memory, and the processor is configured to perform control to cause the plurality of electronic controllers to sleep when no sleep-disabling request is sent from outside the on-board system, and perform control to prevent the plurality of electronic controllers from sleeping when a sleep-disabling request is sent from outside the on-board system, wherein the processor is configured to, when a predetermined condition is satisfied, perform control to cause the plurality of electronic controllers to sleep even when the sleep-disabling request is sent from outside the on-board system.

### BRIEF DESCRIPTION OF THE DRAWINGS

Exemplary embodiments of the present disclosure will be described in detail based on the following figures, wherein:

FIG. 1 is a diagram showing an overview of a present exemplary embodiment.

FIG. 2 is a diagram showing a schematic configuration of an on-board system according to the present exemplary embodiment.

FIG. 3 is a block diagram showing an example of functional structures of a gateway.

FIG. 4 is a flowchart showing a flow of sleep control processing by the gateway.

FIG. 5 is a sequence chart illustrating the sleep control processing of the on-board system.

FIG. 6 is a block diagram showing another example of functional structures of the gateway.

FIG. 7 is a sequence chart illustrating the sleep control processing of the on-board system.

FIG. 8 is a sequence chart illustrating the sleep control processing of the on-board system.

### DESCRIPTION OF EMBODIMENTS

Herebelow, an example of an embodiment of the present disclosure is described with reference to the drawings. In the drawings, structural elements and portions that are the same or equivalent are assigned the same reference symbols. Dimensional proportions in the drawings may be exaggerated for convenience of description and may be different from actual proportions.

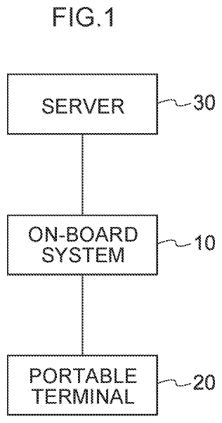

FIG. 1 is a diagram showing an overview of the present exemplary embodiment. An on-board system 10 is a system that is installed in a moving body such as a vehicle or the like. The on-board system 10 executes various kinds of processing in response to both messages generated inside the on-board system 10 and messages sent from outside the on-board system 10. In FIG. 1, a portable terminal 20 is illustrated as a device that sends messages to the on-board system 10. The portable terminal 20 is a terminal used by an occupant of the moving body and may be, for example, an electronic device such as a smartphone or the like.

The on-board system 10 includes functions for sending information to devices outside the moving body. In FIG. 1, a server 30 is illustrated as a device to which the on-board system 10 sends messages.

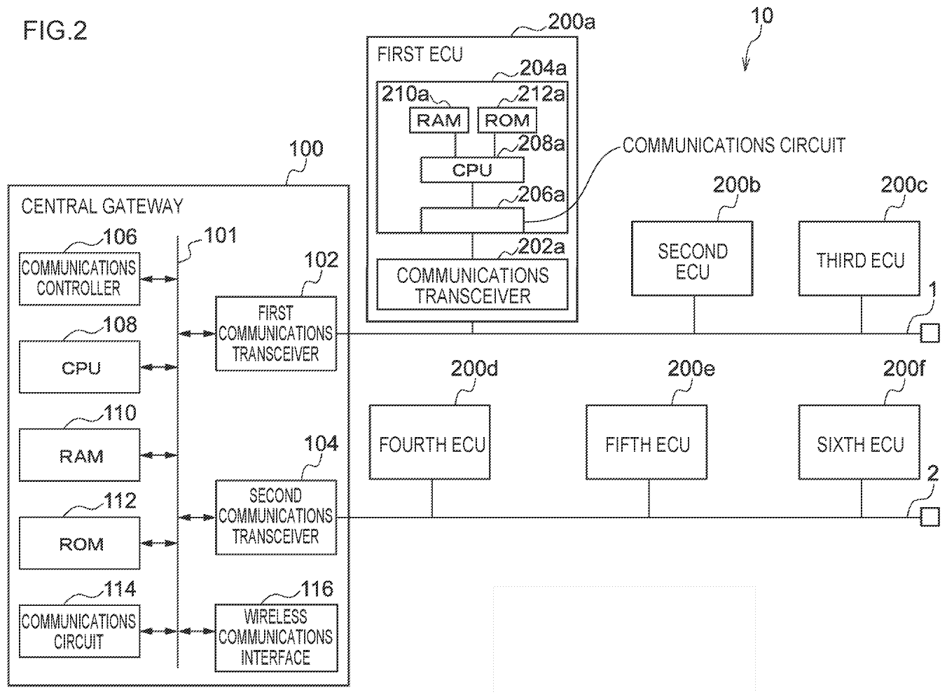

FIG. 2 is a diagram showing a schematic configuration of the on-board system according to the present exemplary embodiment. The on-board system 10 shown in FIG. 2 employs a local area network (LAN) such as CAN, Local Interconnect Network (LIN) or the like. The on-board system shown in FIG. 2 may be applied to information systems, powertrain systems, body systems and the like. Further, the on-board system shown in FIG. 2 may employ FlexRay (registered trademark).

The on-board system 10 is structured by a first communications bus 1, a second communications bus 2, a central gateway 100 (below referred to as “the gateway 100”), a first ECU 200a, a second ECU 200b, a third ECU 200c, a fourth ECU 200d, a fifth ECU 200e and a sixth ECU 200f. The gateway 100 and the first ECU 200a to sixth ECU 200f are operated using an on-board battery as a power source. In the descriptions below, the first ECU 200a to sixth ECU 200f are collectively referred to simply as the ECUs 200.

The gateway 100 is a kind of ECU and is connected by wire with the first communications bus 1 and the second communications bus 2. The first ECU 200a to third ECU 200c are connected by wire by the first communications bus 1, and the fourth ECU 200d to sixth ECU 200f are connected by wire by the second communications bus 2. A first network is structured by the gateway 100 and the first ECU 200a to third ECU 200c, and a second network is structured by the gateway 100 and the fourth ECU 200d to sixth ECU 200.

FIG. 2 shows an example in which three of the ECUs 200 are connected to the first communications bus 1, but one or two of the ECUs 200 may be connected to the first communications bus 1, and four or more of the ECUs 200 may be connected to the first communications bus 1. Furthermore, FIG. 2 shows an example in which three of the ECUs 200 are connected to the second communications bus 2, but one or two of the ECUs 200 may be connected to the second communications bus 2, and four or more of the ECUs 200 may be connected to the second communications bus 2.

As shown in FIG. 2, the first ECU 200a includes a communications transceiver 202a and a microcontroller 204a. A communications circuit 206a, a CPU 208a, random access memory (RAM) 210a and read-only memory (ROM) 212a are embedded in the microcontroller 204a. The CPU 208a is an example of a hardware processor and the RAM 210a is an example of memory. The CPU 208a controls the first ECU 200a as a whole, the RAM 210a is used as a work area for the CPU 208a when the CPU 208a is controlling the first ECU 200a, and the ROM 212a memorizes a first ECU program to be executed by the CPU 208a.

The communications transceiver 202a is connected to the first communications bus 1. In accordance with control by a communications driver, the communications transceiver 202a sends data through the communications circuit 206a to the first communications bus 1, and receives data through the first communications bus 1 and inputs this data to the communications circuit 206a. Thus, the communications transceiver 202a sends and receives signals to and from the gateway 100, the second ECU 200b and the third ECU 200c.

The communications circuit 206a is connected to the communications transceiver 202a. Via the first communications bus 1, the communications circuit 206a conducts serial communications with the gateway 100, the second ECU 200b and the third ECU 200c. The communications circuit 206a sends data from the CPU 208a through the communications transceiver 202a and inputs data inputted through the communications transceiver 202a to the CPU 208a.

The CPU 208a is connected to the communications circuit 206a. The CPU 208a executes processing that controls the first ECU 200a as a whole, such as communication processing executed by the communications circuit 206a and so forth.

Hardware structures of the second ECU 200b to sixth ECU 200f are not shown in the drawings. However, the hardware structures of the second ECU 200b to sixth ECU 200f are similar to the structures of the first ECU 200a.

Hardware structures of the gateway 100 are now described. The gateway 100 includes a first communications transceiver 102, a second communications transceiver 104, a communications controller 106, a CPU 108, RAM 110, ROM 112, a communications circuit 114 and a wireless communications interface 116. The CPU 108 is an example of a hardware processor and the RAM 110 is an example of memory. The first communications transceiver 102, second communications transceiver 104, communications controller 106, CPU 108, RAM 110, ROM 112, communications circuit 114 and wireless communications interface 116 are connected by a bus 101.

The communications controller 106 controls transmission and reception of data by the first communications transceiver 102 and the second communications transceiver 104. The CPU 108 controls the gateway 100 as a whole, the ROM 112 stores a gateway program to be executed by the CPU 108, and the RAM 110 is used as a work area for the CPU 108 when the CPU 108 is conducting control of the gateway 100.

The first communications transceiver 102 is connected to the first communications bus 1. In accordance with control by the communications driver, the first communications transceiver 102 sends data through the communications circuit 114 to the first communications bus 1, and receives data through the first communications bus 1 and inputs this data to the communications circuit 114. Thus, the first communications transceiver 102 sends and receives signals to and from the first ECU 200a to third ECU 200c.

The communications circuit 114 conducts serial communications with the first ECU 200a to third ECU 200c via the first communications bus 1, and conducts serial communications with the fourth ECU 200d to sixth ECU 200f via the second communications bus 2. The communications circuit 114 sends data from the CPU 108 through the first communications transceiver 102 or the second communications transceiver 104, and inputs data inputted through the first communications transceiver 102 or second communications transceiver 104 to the CPU 108. The wireless communications interface 116 conducts wireless communications with devices that are not mounted in the moving body such as, for example, the portable terminal 20 and the server 30. The wireless communications interface 116 employs a wireless communications standard such as, for example, Bluetooth (registered trademark), Long Term Evolution (LTE), 5G, Wi-Fi (registered trademark) or the like.

The CPU 108 executes processing that controls the gateway 100 as a whole, such as communications processing executed by the communications circuit 114 and wireless communications interface 116, and so forth.

When the aforementioned gateway program is being executed, the gateway 100 uses the hardware resources described above to realize various functions. Functional structures realized by the gateway 100 are now described.

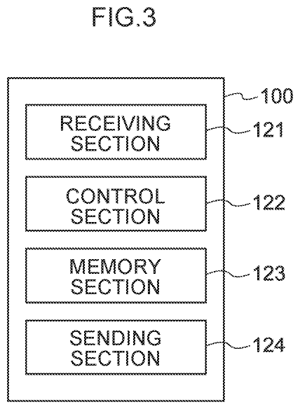

FIG. 3 is a block diagram showing an example of functional structures of the gateway 100.

As shown in FIG. 3, as functional structures, the gateway 100 includes a receiving section 121, a control section 122, a memory section 123 and a sending section 124. The functional structures are realized by the CPU 108 reading and executing the gateway program memorized in the ROM 112.

The receiving section 121 receives messages sent from outside the on-board system 10 and messages sent from the ECUs 200 inside the on-board system 10. Messages that the receiving section 121 receives may include requests that wake up the ECUs 200 when the ECUs 200 are sleeping; in other words, requests that do not allow sleep. A request that does not allow sleep is referred to in the descriptions below as a “sleep-disabling request”.

The control section 122 controls operations of the gateway 100 and the ECUs 200 that are electronically connected to the gateway 100. More specifically, when no sleep-disabling request is sent from outside the on-board system 10, the control section 122 performs control to cause the ECUs 200 to sleep. A request that does not allow sleep is referred to in the descriptions below as a “sleep-disabling request”. When a sleep-disabling request is sent from outside the on-board system 10, the control section 122 performs control to prevent the ECUs 200 from sleeping.

When a predetermined condition is satisfied, the control section 122 performs the control to cause the ECUs 200 to sleep even if a sleep-disabling request is sent from outside the on-board system 10. Because the control is performed to cause the ECUs 200 to sleep even if a sleep-disabling request is sent from outside the on-board system 10 when the predetermined condition is satisfied, the control section 122 may prevent a battery that supplies electricity to the ECUs 200 from running down.

The predetermined condition mentioned above may include one or both of a predetermined duration having passed from when a sleep-disabling request was first sent from outside the on-board system 10, and a remaining charge amount of the battery that supplies electricity to the on-board system 10 falling to or below a predetermined threshold. The predetermined condition may also include the gateway 100 having received a predetermined number of sleep-disabling requests since all the ECUs 200 of the on-board system 10 or a specific ECU 200 woke up.

When the predetermined condition is satisfied, the control section 122 may block messages from outside the on-board system 10. Blocking of messages from outside the on-board system 10 may be implemented by the reception of sleep-disabling requests from outside the on-board system 10 being blocked at the receiving section 121. Further, blocking of messages from outside the on-board system 10 may be implemented by the control section 122 causing the ECUs 200 to sleep even when a sleep-disabling request is received from outside the on-board system 10.

The memory section 123 memorizes a communication history with the outside of the on-board system 10. The sending section 124 sends the communication history memorized by the memory section 123 to the server 30, which memorizes information relating to sleep-disabling requests.

Now, operation of the on-board system 10 is described.

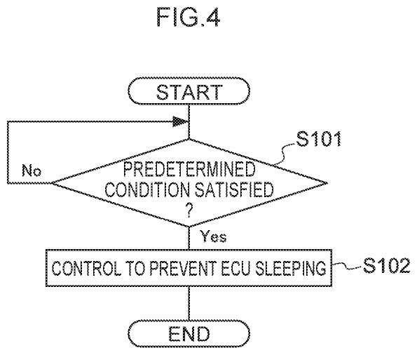

FIG. 4 is a flowchart showing a flow of sleep control processing by the gateway 100. The CPU 108 implements the sleep control processing by reading the gateway program from the ROM 112, loading the program into the RAM 110 and executing the program.

In step S101, the CPU 108 makes a determination as to whether the predetermined condition is satisfied. The predetermined condition may include one or both of the predetermined duration having passed from when a sleep-disabling request was first sent from outside the on-board system 10, and a remaining charge amount of the battery that supplies electricity to the on-board system 10 falling to or below the predetermined threshold.

When the result of the determination in step S101 is that the predetermined condition is not satisfied (“No” in step S101), the CPU 108 waits until the predetermined condition is satisfied. When the result of the determination in step S101 is that the predetermined condition is satisfied (“Yes” in step S101), in step S102 the CPU 108 performs control to cause the ECUs 200 to sleep even if a sleep-disabling request is sent from outside the on-board system 10.

By executing the processing shown in FIG. 4, the CPU 108 may forcibly block a wakeup and cause the ECUs 200 to sleep. By forcibly blocking wakeups and causing the ECUs 200 to sleep, the CPU 108 may prevent the battery from running down.

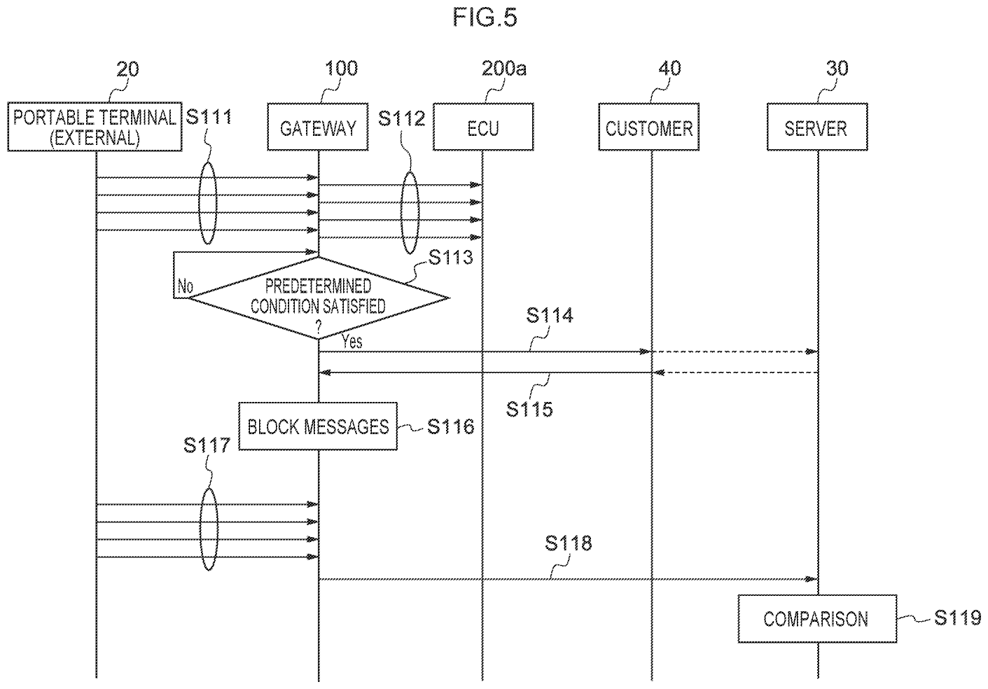

FIG. 5 is a sequence chart illustrating the sleep control processing of the on-board system 10.

When a message containing a sleep-disabling request is sent from the portable terminal 20 in step S111, in step S112 the CPU 108 of the gateway 100 wakes up the ECUs 200 of the on-board system 10 in response to the sleep-disabling request. The CPU 108 of the gateway 100 memorizes the message sent from the portable terminal 20 at the RAM 110.

Hence, the CPU 108 of the gateway 100 waits until the predetermined condition is satisfied in step S113. The predetermined condition may include one or both of the predetermined duration having passed from when a sleep-disabling request was first sent from outside the on-board system 10, and a remaining charge amount of the battery that supplies electricity to the on-board system 10 falling to or below the predetermined threshold. When the predetermined condition is satisfied, in step S114 the CPU 108 of the gateway 100 makes an enquiry to a customer 40 as to whether blocking of messages from the portable terminal 20 is allowed. The customer 40 is, for example, an occupant of the moving body. The CPU 108 may make the enquiry as to whether blocking of messages is allowed to the server 30.

When the CPU 108 of the gateway 100 acquires a response that blocking of messages is allowed from the customer 40 or the server 30 in step S115, the CPU 108 of the gateway 100 blocks messages from the portable terminal 20 in step S116.

The blocking of messages from the portable terminal 20 may be implemented by the CPU 108 blocking the reception of sleep-disabling messages from outside the on-board system 10 at the wireless communications interface 116. Alternatively, the blocking of messages from the portable terminal 20 may be implemented by the CPU 108 causing the ECUs 200 to sleep even if a sleep-disabling request is received from outside the on-board system 10.

In step S117, when a message containing a sleep-disabling request is sent from the portable terminal 20, the CPU 108 of the gateway 100 blocks the message and memorizes the message at the RAM 110. In step S118, at a predetermined timing, the CPU 108 of the gateway 100 sends messages memorized at the RAM 110 to the server 30.

In step S119, when the server 30 receives a message sent from the gateway 100, the server 30 compares the message with a list retained at the server 30 of messages that trigger wakeups. What kind of message is waking up the ECUs 200 may be verified by comparison processing at the server 30.

In the sequence chart shown in FIG. 5, the server 30 retains the list of messages that trigger wakeups but the present disclosure is not limited by this example. The list of messages that trigger wakeups may be retained at the gateway 100.

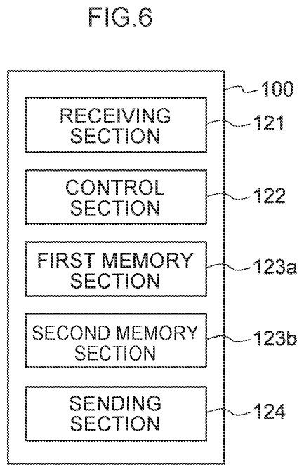

FIG. 6 is a block diagram showing a different example of functional structures of the gateway 100.

As shown in FIG. 6, as functional structures, the gateway 100 includes the receiving section 121, the control section 122, a first memory section 123a, a second memory section 123b and the sending section 124. The functional structures are realized by the CPU 108 reading and executing the gateway program memorized in the ROM 112.

The functional structures of the gateway 100 shown in FIG. 6 differ from the functional structures of the gateway 100 shown in FIG. 3 in that the memory section 123 is divided into the first memory section 123a and the second memory section 123b.

The first memory section 123a memorizes, as information relating to sleep-disabling requests, a list of messages that trigger wakeups. The second memory section 123b memorizes, as a communication history with the outside of the on-board system 10, messages that contain sleep-disabling requests, in which the content of a message sent from outside matches the information memorized at the first memory section 123a. The sending section 124 sends the information of the messages containing sleep-disabling requests memorized at the second memory section 123b to the server 30.

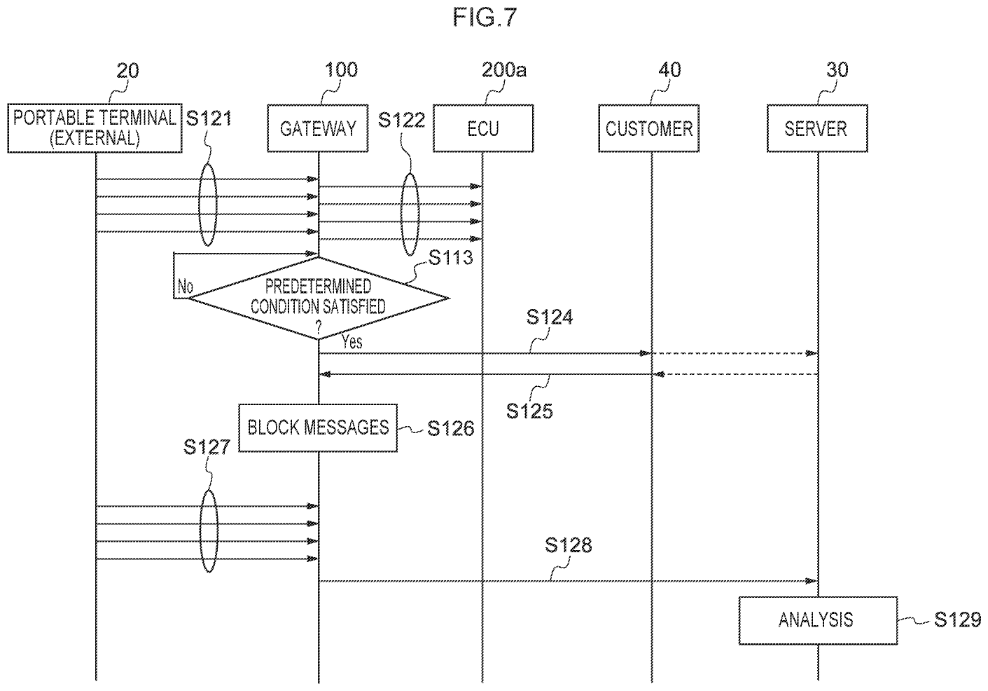

FIG. 7 is a sequence chart illustrating the sleep control processing of the on-board system 10.

When a message containing a sleep-disabling request is sent from the portable terminal 20 in step S121, in step S122 the CPU 108 of the gateway 100 wakes up the ECUs 200 of the on-board system 10 in response to the sleep-disabling request that is sent. The CPU 108 of the gateway 100 compares the message with the memorized list of messages that trigger wakeups and memorizes, at the RAM 110, a message that triggers a wakeup that is included in the message sent from the portable terminal 20.

Hence, the CPU 108 of the gateway 100 waits until the predetermined condition is satisfied in step S123. The predetermined condition may include one or both of the predetermined duration having passed from when a sleep-disabling request was first sent from outside the on-board system 10, and a remaining charge amount of the battery that supplies electricity to the on-board system 10 falling to or below the predetermined threshold. When the predetermined condition is satisfied, in step S124 the CPU 108 of the gateway 100 makes an enquiry to the customer 40 as to whether blocking of messages from the portable terminal 20 is allowed. The customer 40 is, for example, an occupant of the moving body. The CPU 108 may make the enquiry as to whether blocking of messages is allowed to the server 30.

When the CPU 108 of the gateway 100 acquires a response that blocking of messages is allowed from the customer 40 or server 30 in step S125, the CPU 108 of the gateway 100 blocks messages from the portable terminal 20 in step S126.

The blocking of messages from the portable terminal 20 may be implemented by the CPU 108 blocking the reception of sleep-disabling messages from outside the on-board system 10 at the wireless communications interface 116. Alternatively, the blocking of messages from the portable terminal 20 may be implemented by the CPU 108 causing the ECUs 200 to sleep even if a sleep-disabling request is received from outside the on-board system 10.

In step S127, when a message containing a sleep-disabling request is sent from the portable terminal 20, the CPU 108 of the gateway 100 blocks the message and memorizes the message at the RAM 110. In step S128, at a predetermined timing, the CPU 108 of the gateway 100 sends messages memorized at the RAM 110 to the server 30.

In step S129, when the server 30 receives a message sent from the gateway 100, the server 30 analyzes the message. What kind of message is waking up the ECUs 200 may be verified by analysis processing at the server 30.

When a message from outside contains a sleep-disabling request, whether the message is a message to cause the ECUs 200 to wake up or not may be verified by the processing described above. However, the ECUs 200 may continually wake up and the battery remaining charge amount may fall even when there is no message containing a sleep-disabling request. In this situation, it is possible for the battery remaining charge amount to be reduced by repeated sleeps and wakeups that are caused not by wakeups due to messages containing sleep-disabling requests but by internal factors. Below, operation of the on-board system 10 to identify a cause due to internal factors that leads to repeated sleeps and wakeups is described.

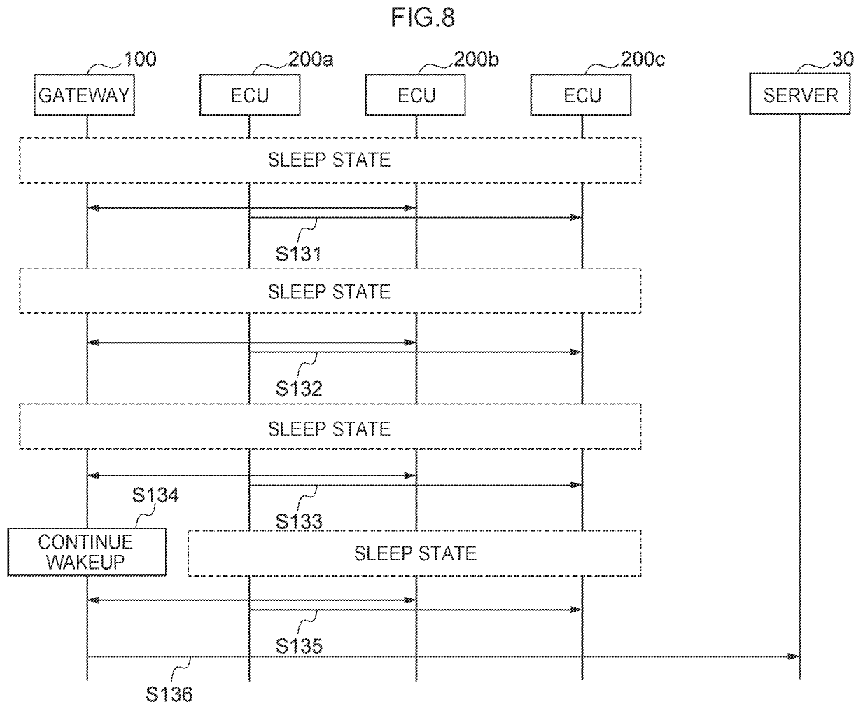

FIG. 8 is a sequence chart illustrating the sleep control processing of the on-board system 10. In FIG. 8, the first ECU 200a, second ECU 200b and third ECU 200c are shown as the ECUs 200.

When identifying a cause due to internal factors that leads to repeated sleeps and wakeups, the CPU 108 of the gateway 100 first notifies a customer that messages from outside are to be blocked. The notification to the customer that messages from the outside are to be blocked is as described in the descriptions of the sleep control processing using FIG. 5 and FIG. 7.

Subsequently, each of the gateway 100, the first ECU 200a, the second ECU 200b and the third ECU 200c goes into the sleep state thereof. In step S131, the first ECU 200a sends a message containing a sleep-disabling request through the first communications bus 1. Each of the gateway 100, the second ECU 200b and the third ECU 200c is woken up by the message sent by the first ECU 200a.

Thereafter, each of the gateway 100, the first ECU 200a, the second ECU 200b and the third ECU 200c goes into the sleep state. In step S132 and step S133, the first ECU 200a again sends a message containing a sleep-disabling request through the first communications bus 1. Thus, each of the gateway 100, the first ECU 200a, the second ECU 200b and the third ECU 200c repeatedly wakes up and sleeps.

When the number of wakeups per unit time exceeds a predetermined threshold, in step S134 the CPU 108 of the gateway 100 continues the wakeup state of the gateway 100 rather than causing the gateway 100 to sleep.

In step S135, the first ECU 200a again sends a message containing a sleep-disabling request through the first communications bus 1. At this time, because the gateway 100 is in the wakeup state, the gateway 100 may recognize that the sender of the message containing the sleep-disabling request through the first communications bus 1 is the first ECU 200a. More specifically, the gateway 100 stores, at the RAM 110, a CAN source node ID that initially sent a network management message or is continually sending a network management message and the content of the message.

Then, in step S136, the CPU 108 of the gateway 100 sends the message sent by the first ECU 200a and memorized at the RAM 110 to the server 30. The server 30 may verify what kind of message is waking up the ECUs 200 in the on-board system 10 by analyzing the message sent from the gateway 100.

Factors that wake up the ECUs 200 include factors arising from vehicle occupants and factors arising from requests from the outside. When a wakeup is continually requested from the outside, the gateway 100 forcibly blocks wakeups and causes the ECUs 200 to sleep. When a wakeup is continually requested from the outside, the gateway 100 may identify a factor leading to the battery running down by recording messages from the outside.

The sleep control processing that, in the exemplary embodiment described above, is executed by a CPU reading software (a program) may be executed by various kinds of processor other than a CPU. Examples of processors in these cases include a PLD (programmable logic device) in which a circuit configuration can be modified after manufacturing, such as an FPGA (field programmable gate array) or the like, a dedicated electronic circuit which is a processor with a circuit configuration that is specially designed to execute specific processing, such as an ASIC (application-specific integrated circuit) or the like, and so forth. The sleep control processing may be executed by one of these various kinds of processors, and may be executed by a combination of two or more processors of the same or different kinds (for example, plural FPGAs, a combination of a CPU with an FPGA, or the like). Hardware structures of these various kinds of processors are, to be more specific, electronic circuits combining circuit components such as semiconductor components and the like.

In the exemplary embodiment described above, modes are described in which the sleep control program is memorized in advance (installed) at a ROM or storage, but this is not limiting. The program may be provided in a mode recorded on a non-transitory recording medium, such as a CD-ROM (compact disc read-only memory), DVD-ROM (digital versatile disc read-only memory), USB (universal serial bus) memory or the like. Modes are also possible in which the program is downloaded from external equipment via a network.

The present disclosure is made in consideration of the matter described above; an object of the present disclosure is to provide an on-board system, an on-board system control method and a non-transitory recording medium that cause ECUs to sleep even when a wakeup is continually requested from outside.

A first aspect of the disclosure is an on-board system that includes a plurality of electronic controllers and a gateway electronically connected to the plurality of electronic controllers. The gateway includes a memory and a processor coupled to the memory, and the processor is configured to perform control to cause the plurality of electronic controllers to sleep when no sleep-disabling request is sent from outside the on-board system, and perform control to prevent the plurality of electronic controllers from sleeping when a sleep-disabling request is sent from outside the on-board system, wherein the processor is configured to, when a predetermined condition is satisfied, perform control to cause the plurality of electronic controllers to sleep even when the sleep-disabling request is sent from outside the on-board system.

In the on-board system according to the first aspect, if the predetermined condition is satisfied, then when the gateway performs control to cause the plural electronic controllers to sleep, the on-board system performs the control to cause the plural electronic controllers to sleep even if a sleep-disabling request is sent from outside the on-board system. According to the on-board system of the first aspect, ECUs may be caused to sleep even when a wakeup is continually requested from outside.

A second aspect of the disclosure is the on-board system of the first aspect, wherein the processor is configured to receive the sleep-disabling request from outside the on-board system, when the predetermined condition is not satisfied and the sleep-disabling request is received from outside the on-board system, not perform control to cause the plurality of electronic controllers to sleep and when the predetermined condition is satisfied, perform control to block reception of the sleep-disabling request from outside the on-board system and allow the plurality of electronic controllers to sleep.

In the on-board system according to the second aspect, if the predetermined condition is satisfied when the gateway performs control to cause the plural electronic controllers to sleep, the on-board system performs the control to cause the plural electronic controllers to sleep with the processor blocking sleep-disabling requests from outside the on-board system. According to the on-board system of the second aspect, the ECUs may be caused to sleep by sleep-disabling requests from outside being blocked.

A third aspect of the disclosure is the on-board system of the first aspect, wherein the processor is configured to receive the sleep-disabling request from outside the on-board system, when the predetermined condition is not satisfied and the sleep-disabling request is received from outside the on-board system, not perform control to cause the plurality of electronic controllers to sleep and when the predetermined condition is satisfied, perform control to cause the plurality of electronic controllers to sleep even when the sleep-disabling request is received from outside the on-board system.

In the on-board system according to the third aspect, if the predetermined condition is satisfied when the gateway performs control to cause the plural electronic controllers to sleep, the on-board system performs the control to cause the plural electronic controllers to sleep even when a receiving section receives a sleep-disabling request from outside the on-board system. According to the on-board system of the third aspect, the ECUs may be caused to sleep even when a sleep-disabling request is continually received from outside.

A fourth aspect of the disclosure is the on-board system of the first aspect, wherein the predetermined condition includes at least one of a predetermined duration passing after the sleep-disabling request is first sent from outside the on-board system and a remaining charge amount of a battery that supplies electricity to the on-board system being equal to or below a predetermined threshold.

In the on-board system according to the fourth aspect, when the gateway performs control to cause the plural electronic controllers to sleep, either of the predetermined duration passing from when the sleep-disabling request was first sent and a remaining charge amount of the battery that supplies electricity to the on-board system falling to or below the predetermined threshold is the condition for performing the control to cause the plural electronic controllers to sleep. According to the on-board system of the fourth aspect, the ECUs may be caused to sleep even when a sleep-disabling request is continually received from outside.

A fifth aspect of the disclosure is the on-board system of the first aspect, wherein the gateway stores a communication history with the outside of the on-board system, and the processor is configured to send the communication history to a server that stores information relating to the sleep-disabling request.

In the on-board system according to the fifth aspect, when the gateway performs control to cause the plural electronic controllers to sleep, a communication history with the outside of the on-board system is memorized and information relating to sleep-disabling requests is transmitted to the server. According to the on-board system of the fifth aspect, analysis of factors that impede sleep of electronic controllers is facilitated.

A sixth aspect of the disclosure is the on-board system of the first aspect, wherein the gateway stores information relating to the sleep-disabling request and a communication history with the outside of the on-board system that is based on the information relating to the sleep-disabling request, and the processor is configured to send the communication history to a server.

In the on-board system according to the sixth aspect, when the gateway performs control to cause the plural electronic controllers to sleep, information relating to sleep-disabling requests from outside the on-board system is memorized and the memorized information is sent to the server. According to the on-board system of the sixth aspect, analysis of factors that impede sleep of electronic controllers is facilitated.

A seventh aspect of the disclosure is an on-board system control method that controls an on-board system including a plurality of electronic controllers and a gateway electronically connected to the plurality of electronic controllers. The method includes a processor of the gateway performing control to cause the plurality of electronic controllers to sleep when no sleep-disabling request is sent from outside the on-board system, and performing control to prevent the plurality of electronic controllers from sleeping when a sleep-disabling request is sent from outside the on-board system, wherein, when a predetermined condition is satisfied, the processor performs control to cause the plurality of electronic controllers to sleep even when the sleep-disabling request is sent from outside the on-board system.

In the on-board system control method according to the seventh aspect, if the predetermined condition is satisfied, then when the gateway performs control to cause the plural electronic controllers to sleep, the on-board system performs the control to cause the plural electronic controllers to sleep even if a sleep-disabling request is sent from outside the on-board system. According to the on-board system control method of the seventh aspect, ECUs may be caused to sleep even when a wakeup is continually requested from outside.

An eighth aspect of the disclosure is a non-transitory recording medium storing a program executable by a computer provided at a gateway to execute processing controlling an on-board system that includes a plurality of electronic controllers and the gateway which is electronically connected to the plurality of electronic controllers. The processing includes performing control to cause the plurality of electronic controllers to sleep when no sleep-disabling request is sent from outside the on-board system, and performing control to prevent the plurality of electronic controllers from sleeping when a sleep-disabling request is sent from outside the on-board system, wherein, when a predetermined condition is satisfied, the processing performs control to cause the plurality of electronic controllers to sleep even when the sleep-disabling request is sent from outside the on-board system.

In the non-transitory recording medium according to the eighth aspect, if the predetermined condition is satisfied, then when the gateway performs control to cause the plural electronic controllers to sleep, the on-board system performs the control to cause the plural electronic controllers to sleep even if a sleep-disabling request is sent from outside the on-board system. According to the non-transitory recording medium of the eighth aspect, ECUs may be caused to sleep even when a wakeup is continually requested from outside.

According to the present disclosure, an on-board system, an on-board system control method and a non-transitory recording medium may be provided that cause ECUs to sleep when a predetermined condition is satisfied, even if a wakeup is continually requested from outside.

What is claimed is:

1. An on-board system comprising:
a plurality of electronic controllers; and
a gateway electronically connected to the plurality of electronic controllers, the gateway including a memory and a processor coupled to the memory, the processor being configured to:
perform control to cause the plurality of electronic controllers to sleep when no sleep-disabling request is sent from outside the on-board system, and
perform control to prevent the plurality of electronic controllers from sleeping when a sleep-disabling request is sent from outside the on-board system,
wherein the processor is configured to, when a predetermined condition is satisfied, perform control to cause the plurality of electronic controllers to sleep even when the sleep-disabling request is sent from outside the on-board system.

2. The on-board system according to claim 1, wherein the processor is configured to:
receive the sleep-disabling request from outside the on-board system;
when the predetermined condition is not satisfied and the sleep-disabling request is received from outside the on-board system, not perform control to cause the plurality of electronic controllers to sleep; and
when the predetermined condition is satisfied, perform control to block reception of the sleep-disabling request from outside the on-board system and allow the plurality of electronic controllers to sleep.

3. The on-board system according to claim 1, wherein the processor is configured to:
receive the sleep-disabling request from outside the on-board system;
when the predetermined condition is not satisfied and the sleep-disabling request is received from outside the on-board system, not perform control to cause the plurality of electronic controllers to sleep; and
when the predetermined condition is satisfied, perform control to cause the plurality of electronic controllers to sleep even when the sleep-disabling request is received from outside the on-board system.

4. The on-board system according to claim 1, wherein the predetermined condition includes at least one of:
a predetermined duration passing after the sleep-disabling request is first sent from outside the on-board system, and
a remaining charge amount of a battery that supplies electricity to the on-board system being equal to or below a predetermined threshold.

5. The on-board system according to claim 1, wherein:
the gateway stores a communication history with the outside of the on-board system, and
the processor is configured to send the communication history to a server that stores information relating to the sleep-disabling request.

6. The on-board system according to claim 1, wherein:
the gateway stores:
information relating to the sleep-disabling request, and
a communication history with the outside of the on-board system that is based on the information relating to the sleep-disabling request; and
the processor is configured to send the communication history to a server.

7. An on-board system control method that controls an on-board system including a plurality of electronic controllers and a gateway electronically connected to the plurality of electronic controllers, the method comprising a processor of the gateway:
performing control to cause the plurality of electronic controllers to sleep when no sleep-disabling request is sent from outside the on-board system; and
performing control to prevent the plurality of electronic controllers from sleeping when a sleep-disabling request is sent from outside the on-board system,
wherein, when a predetermined condition is satisfied, the processor performs control to cause the plurality of electronic controllers to sleep even when the sleep-disabling request is sent from outside the on-board system.

8. A non-transitory recording medium storing a program executable by a computer provided at a gateway to execute processing controlling an on-board system that includes
a plurality of electronic controllers, and
the gateway being electronically connected to the plurality of electronic controllers, the processing comprising:
performing control to cause the plurality of electronic controllers to sleep when no sleep-disabling request is sent from outside the on-board system; and
performing control to prevent the plurality of electronic controllers from sleeping when a sleep-disabling request is sent from outside the on-board system,
wherein, when a predetermined condition is satisfied, the processing performs control to cause the plurality of electronic controllers to sleep even when the sleep-disabling request is sent from outside the on-board system.
